(19) United States
(12) Patent Application Publication
(10) Pub. No.: US 2003/0177364 A1
(43) Pub. Date: Sep. 18, 2003

(54) Method for authenticating users

(76) Inventors: Robert E. Walsh, Foster City, CA (US); Mark C. Terranova, Maynard, MA (US)

Correspondence Address: HOYT A. FLEMING III, P.O. BOX 140678, BOISE, ID, 83714, US

(21) Appl. No.: 10/099,585

(22) Filed: Mar. 15, 2002

(51) Int. Cl. G06F 9/44

(52) U.S. Cl. 713/182

(57) ABSTRACT

A method of authenticating a user to access a client computer and a remote computer, such as a web server or a directory server, which is coupled to the client computer via the Internet. The method includes receiving credential(s) from the user and granting the user access to the client computer based upon the credential(s). The method also includes transmitting the credential(s) from the client computer to an identity provider server and granting the user access to the remote computer based in part upon the credential(s).

### 1. FIELD OF THE INVENTION

The present invention generally relates to methods and systems for authenticating users of computer resources. More specifically, the present invention relates to efficient methods and systems for authenticating users to access both client computers and remote computers, such as web servers and directory servers, with a single set of credentials.

### 2. BACKGROUND

As is well known, users of computer systems are often required to provide certain information (“credentials”) to the computer systems so that the computer systems can authenticate the users' identities. For example, one well-known authentication system is Microsoft's NT LAN Manager (“NTLM”).

A user desiring to access a client computer that is secured by NTLM first enters the user's credentials, such as the user's username, password, an d domain name, into a client computer. Such credentials are typically entered into the client computer via a logon screen. After receiving the credentials, the client computer then computes a cryptographic hash of the password and discards the actual password. Next, the client computer sends the username to a server in plain text. Then, the server generates a random number, which is known as a challenge, and sends the random number to the client computer. The client computer encrypts this challenge with the hash of the user's password and returns the result, which is known as a response, to the server. The server then sends the user's name, challenge and response to a domain controller. The domain controller uses the information to retrieve the hash of the user's password from a Security Account Manager database. It then uses the password hash to encrypt the challenge. Finally, the domain controller compares the encrypted challenge it computed with the response computed by the client computer. If they are identical, then authentication is successful. Additional information of NTLM can be found at www.msdn.microsoft.com.

After the user's identity is authenticated, the user can utilize the client computer and the client's computer system's local resources, such as the client computer's local hard disk drive(s) and CD ROM disk drive(s). The user may also be able to access a limited number of computer resources that are administered by the same entity that administers the client computer. However, even after logging into the client computer, in many circumstances, the user cannot utilize all of the computer resources that the user desires. For example, if the user desires to purchase a product over the Internet from a remote computer, which is typically administered by a different entity, then the user must provide new credentials so that the remote computer can authenticate the user's identity.

In an effort to reduce the number of times that users provide their credentials to online merchants, Microsoft developed a service that provides Internet authentication for different websites. This system is known as Microsoft Passport.

Microsoft Passport provides authentication services for multiple websites by hosting a secure central database that contains users' authentication credentials and identifiers. The identifiers are referred to as Passport Unique IDs (“PUIDs”). When a user attempts to logon to a secure portion of a website, the user is typically redirected to a secure Microsoft logon server. The logon server first verifies that the website requesting the authentication is a valid participating site, i.e., a Microsoft Passport Partner website. Then, the logon server requests the user's passport credentials. Next, the logon server verifies that the credentials correspond to a valid Passport user. The logon server then encrypts, using the website's public key, the user's PUID. Next, the logon server sends the encrypted PUID to the website. Using the website's private key, the website's server decrypts the user's PUID. Thus, the user is authenticated to utilize the secure portions of the website. As a result, Microsoft's Passport system can be utilized to logon to secure websites using one set of credentials.

If the user also desires to access additional computer resources, such as directory services that are accessed via the Lightweight Directory Access Protocol (“LDAP”), then the user must enter additional credentials in order to gain access to the directory computer that is hosting the directory services.

While Microsoft's Passport system does decrease the number of times that a user is required to enter identifying information to access secure web servers, it does not allow the user to have a single logon for gaining access to a secure client computer and secure websites. Similarly, Microsoft's Passport does not allow the user to have a single logon for gaining access to secure LDAP directories. Further, there is significant concern that a proprietary system, such as Microsoft's Passport, places users and online vendors of products at a significant disadvantage. For example, if Microsoft charges a substantial fee to online vendors for the use of Microsoft's Passport system, then the fee would have to be passed on to the users who are purchasing products from the vendors.

Thus, a need exists for a non-proprietary authentication system that reduces the number of times that a user is required to enter credentials while providing access to a large number and type of computing resources.

### 3. SUMMARY OF INVENTION

One embodiment of the invention is a method of authenticating a user to access a client computer and a remote computer, such as a web server or a directory server, which is coupled to the client computer via the Internet. The method includes receiving credential(s) from the user and granting the user access to the client computer based upon the credential(s). The method also includes transmitting the credential(s) from the client computer to an identity provider server and granting the user access to the remote computer based in part upon the credential(s).

### 4. BRIEF DESCRIPTION OF THE FIGURES

FIG. 1 presents a client computer that is coupled to a web server, an identity provider, and a directory server via the Internet.

FIG. 2 presents a logon screen.

FIG. 3 presents one embodiment of a method of authenticating a user to access a client computer, a web server, and a directory server.

### 5. DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

One embodiment of the invention is a method of gaining access to a plurality of secure computers by entering into a client computer a single set of user credentials. As is discussed below, the secure computers may include a client computer, remote computers accessed by the hypertext transport protocol (“http”), remote computers accessed by the secure hypertext transport protocol (“s-http”), and/or directory services accessed by the LDAP.

5.1 Logon Screen

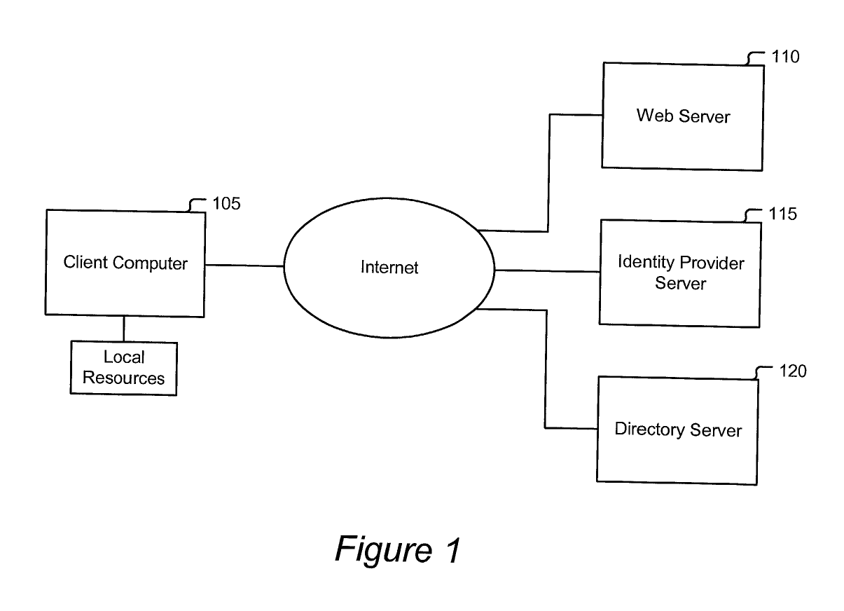

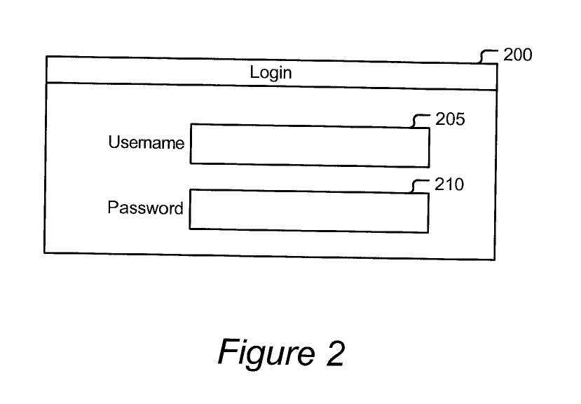

In one embodiment of the invention, a user desiring to access a client computer 105 and a remote computer 110, as shown in FIG. 1, would first “power on” the client computer. After the client computer 105 completes its boot process, the client computer 105 could display a logon screen 200 such as shown in FIG. 2. The logon screen 200 could include a first field 205 for receiving a username and a second field 210 for receiving a password. The logon screen could also include fields for receiving additional information (not shown), such as a domain name. In some embodiments of the invention, the logon screen could be generated by Microsoft's Winlogon component. As is well known, Winlogon is an executable program that is included with several Microsoft Windows operating systems. Winlogon provides interactive logon support. Additional information on Microsoft's Winlogon may be found at www.msdn.microsoft.com.

5.2 Logon

In some embodiments of the invention, the user initiates the logon process by entering the user's credentials into the client computer 105. For example, the user may enter a username, such as “Alice,” into the first field 205 and enter a password, such as “Wonderland,” into the second field 210.

5.3 Granting Access to the Client Computer

After the user has entered the user's credentials into the client computer 105, the client computer 105 begins to authenticate the user so that the user can gain access to the client computer 105. For example, in one embodiment of the invention, after receiving the credentials, the client computer 105 could compute a cryptographic hash of the password and discard the actual “clear text” password. Next, the client computer could send the user name to a server in clear text or in an encrypted format. Then, the server could generate a challenge, and send the challenge to the client computer 105. The client computer could then generate and transmit a response to the server. The server then could send the user name, challenge, and response to a domain controller. The identity of the domain controller could be entered into the client computer by the user or could be set by a system administrator. The domain controller could use the information to retrieve the hash of the user's password from a Security Account Manager database. The domain controller could then use the password hash to encrypt the challenge. Finally, the domain controller could compare the encrypted challenge it computed with the response computed by the client computer. If they are identical, then authentication is successful. Thus, the user would be granted access to the client computer system.

In other embodiments of the invention, authentication methods, some of which are less complex and some of which are more complex, could be utilized to grant the user access to the client computer system. Many such methods are known in the art and could be utilized in the present invention.

In some embodiments of the invention, portions of the above methods could be performed by a Graphical Identification and Authentication dynamic-link library, which is often referred to as GINA. As is well known, Microsoft includes GINAs in many of its operating systems. In addition, GINAs are also available from several other vendors.

Additional information on GINAs may be found at www.msdn.microsoft.com.

5.4 Granting Access to a Web Server

After the user has logged on to the client computer 105, the user may desire to utilize resources of one or more remote computers, such as a web server 110, that communicates with the client computer 105 via http or s-http. The web server 110 could be connected to the client computer 105 by a local-area network or a wide-area network, such as the Internet. In addition, the web server 110 may be administered by an entity that is independent of the entity that administers the client computer 105. For example, Sun Microsystems, Inc, which administers client computers and secure websites, is “independent” from Yahoo.com and Amazon.com, which administer separate and distinct secure websites.

In some embodiments of the invention, the username that the user utilized to logon to the client computer 105 would also be utilized to logon to the web server 110. In other embodiments of the invention, the username, password (or a hash of the password), and a domain name would be utilized to logon to the web server 110.

For example, when a user attempts to access a secured portion of the web server 110, the user could be redirected to a secure server 115 administered by an identity provider 115. One such identity provider is the Liberty Alliance Project. Additional information relating to the Liberty Alliance Project can be found at www.projectliberty.org. The identity provider server 115 could verify that the web server 110 requesting authentication of the user is a web server that is administered by an affiliate of the identity provider. Then, the server could request the username and a hash of the password that the user utilized to logon to the client computer 105. Next, the identity provider server 115 could verify that the username corresponds to a valid identity provider user. The identity provider server 115 could then encrypt, using the web server's public key, the user's identification number (“ID”). Next, the identity provider server 115 could send the encrypted ID to the web server 110. Using the web server's private key, the web server 110 could decrypt the user's ID. Thus, the user would be authenticated, could gain access to and could utilize the secured resources of the web server 110. As a result of the above process, the user need not provide any additional information to the identity provider server 115 or the web server 110 to gain access to a secured website that is hosted on the web server 110.

In some embodiments of the invention, the identity provider server 115 also encrypts the ID with the user's public key and sends the encrypted ID to the client computer 105. In such embodiments, the client computer 105 could store the encrypted ID. In some embodiments, the encrypted ID could be stored in a process memory store such as RAM. In other embodiments, the encrypted ID could be stored in a persistent store such as a browser cache, a file, or a certificate store. After storing the encrypted ID, the client computer could decrypt the encrypted ID using the user's private key and utilize the ID to access other secure web servers (not shown).

In other embodiments of the invention, other authentication methods, some of which are less complex and some of which are more complex that the method discussed above, could be utilized to grant the user access to the remote computer. Many such methods are known in the art and could be utilized in the present invention. For example, instead of redirecting the client computer to the identity provider server 115, the web server 110 could request that the client computer 105 provide the web server 110 with the user's username and the hash of the user's password. After the web server 110 receives these credentials, it could forward them to the identity provider server 120. Many such variations are intended to be within the scope of this invention. In addition, a GINA may perform portions of the above authentication process. Further, in some embodiments of the invention, the user's credentials could be converted into a different encoding standard such as Unicode, the international character-encoding standard.

5.5 Granting Access to Directory Services

In some embodiments of the invention, the user's credentials may also be utilized to gain access to directory services that are accessed by LDAP. A directory server 120 that hosts such directory services could be connected to the client computer 105 by a local-area network or a wide-area network, such as the Internet. In addition, such a directory server 120 may be administered by an entity that is independent of the entity that administers the client computer 105.

In one embodiment of the invention, when a user attempts to access a secure directory on the directory server 120, the user could be redirected to the identity provider server 115. The identity provider server 115 could verify that the directory server 120 requesting authentication of the user is a server that is administered by an affiliate of the identity provider. Then, the identity provider server 115 could request the username and a hash of the password that the user utilized to logon to the client computer 105. Next, the identity provider server could verify that the username corresponds to a valid identity provider user. The identity provider server 115 could then encrypt, using the directory server's public key, the user's identification number (“ID”). Next, the identity provider server could send the encrypted ID to the directory server 120. Using the directory server's private key, the directory server 120 could decrypt the user's ID. Thus, the user would be authenticated, could gain access to and could utilize the secured directories hosted by the directory server 120. As a result of the above process, the user need not provide any additional information to the identity provider server 115 or the directory server 120 to gain access to secure directory services.

In other embodiments of the invention, authentication methods, some of which are less complex and some of which are more complex than the authentication method discussed above, could be utilized to grant the user access to the directory server 120. Many such methods are known in the art and could be utilized in the present invention. In addition, a GINA may perform portions of the above process.

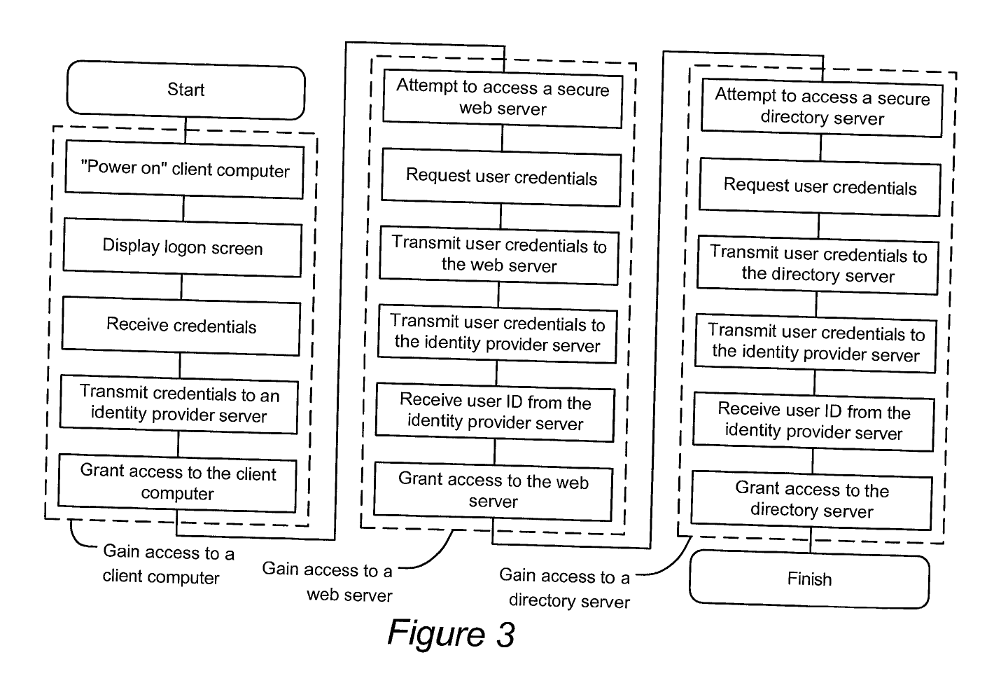

A summary of a method utilized to authenticate a user and provide access to a client computer 105, a web server 110, and a directory server 120 is provided in FIG. 3.

5.6 Other Methods of Granting Access to the Client Computer

In other embodiments of the invention, the identity provider server 115 may also be utilized to grant access to the client computer. In such embodiments, the identity provider server 115 would receive the user's credentials, such as a user name and a hash of the user's password. The identity server 115 would utilize the credentials to authenticate the user and grant the user access to the client computer 105.

In such an embodiment, the logon screen 200 may include a field to specify the identity provider that will be utilized to authenticate the user. Alternatively, a system administrator may specify the identity provider. By providing a system administrator the ability to select the identity provider used to authenticate users, increased competition in the authentication market can be realized.

5.7 Other Credentials

The above methods utilized username, passwords and hashes of passwords to authenticate a user. Alternatively, or in addition to, other credentials could be utilized. For example, an authentication method may utilize data that is stored on an electronic device, such as a smart card or a digital key, to authenticate a user. Additional information on smart card logon may be found at www.microsoft.com/windows2000/docs/sclogonwp.doc. An authentication method may also utilize a user's biometric data, such as retinal images or fingerprints to authenticate a user.

5.8 Conclusion

The foregoing descriptions of embodiments of the present invention have been presented for purposes of illustration and description only. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

It is claimed:

1. A method of authenticating a user to access a client computer and a remote computer that is coupled to the client computer via the internet:
a) receiving at least one credential from the user;
b) granting the user access to the client computer based in part upon the at least one credential;
c) transmitting the at least one credential from the client computer to an identity provider server; and
d) granting the user access to the remote computer based in part upon the at least one credential.

2. The method of claim 1, wherein the act of receiving the at least one credential includes receiving the credential before the user is logged into the client computer.

3. The method of claim 1, wherein the act of receiving the at least one credential includes receiving a username before the user is logged into the client computer.

4. The method of claim 1, wherein the act of receiving the at least one credential includes receiving a password before the user is logged into the client computer.

5. The method of claim 4, wherein the act of receiving the password includes generating a cryptographic hash of the password and discarding the password.

6. The method of claim 1, wherein the act of receiving the at least one credential includes receiving the at least one credential by a Microsoft Winlogon program.

7. The method of claim 1, wherein the act of granting the user access to the client computer includes transmitting the at least one credential to the identity provider server.

8. The method of claim 1, wherein the act of granting the user access to the client computer includes transmitting the at least one credential to a server that is administered by an entity that is independent from the entity that administers the identity provider server.

9. The method of claim 1, wherein the act of transmitting the at least one credential from the client computer includes transmitting the at least one credential from the client computer to the remote computer and transmitting the at least one credential from the remote computer to the identity provider server.

10. The method of claim 1, wherein the act of transmitting the at least one credential from the client computer to the remote computer occurs after the user has been granted access to the client computer.

11. The method of claim 1, further comprising displaying a screen on the client computer, the screen containing a first field for receiving the at least one credential.

12. The method of claim 11, wherein the act of displaying the screen on the client computer includes displaying a logon screen.

13. The method of claim 11, wherein the act of displaying the screen containing on the client computer includes displaying a screen that contains a field for receiving a username.

14. The method of claim 11, wherein the act of displaying the screen containing on the client computer includes displaying a screen that contains a field for receiving a password.

15. The method of claim 11, wherein the act of displaying the screen containing on the client computer includes displaying a screen that contains a field for receiving a domain name.

16. The method of claim 1, wherein the act of receiving the at least one credential includes receiving data from a smart card.

17. The method of claim 1, wherein the act of receiving the at least one credential includes receiving data from a digital key.

18. The method of claim 1, wherein the act of receiving the at least one credential includes receiving biometric data.

19. The method of claim 1, wherein the act of granting the user access to the remote computer includes granting the user access to a web server.

20. The method of claim 1, wherein the act of granting the user access to the remote computer includes granting the user access to a secure portion of a web server.

21. The method of claim 1, wherein the act of granting the user access to the remote computer includes granting the user access to a directory server.

22. The method of claim 1, wherein the act of granting the user access to the remote computer includes granting the user access to a secure portion of a directory server.

23. A system for authenticating a user to access a client computer and a remote computer that is coupled to the client computer via the internet, the system comprising:
a) means for receiving at least one credential from the user;
b) means for granting the user access to the client computer based in part upon the at least one credential;
c) means for transmitting the at least one credential from the client computer to an identity provider server; and
d) means for granting the user access to the remote computer based in part upon the at least one credential.
